(19) United States
(12) Patent Application Publication
(10) Pub. No.: US 2013/0164504 A1
(43) Pub. Date: Jun. 27, 2013

(54) Elastic Bands with Hidden Messages

(71) Applicant: Sean Mullaney, Cincinnati, OH (US)

(72) Inventor: Sean Mullaney, Cincinnati, OH (US)

(21) Appl. No.: 13/337,715

(22) Filed: Dec. 27, 2011

(51) Int. Cl. B32B 3/00

(52) U.S. Cl. 428/195.1

(57) ABSTRACT

A band capable of being stretched includes a first indicia being positioned on a first portion of the band and being in a readily recognizable form only when the band is in a stretched condition, such form changing to an un-recognizable form when the band is in an un-stretched position. In addition, the band may further include a second indicia being positioned on a second portion of the band and being in a readily recognizable form when the band is in an un-stretched position.

### BACKGROUND OF THE INVENTION

The present invention relates to elastic bands typically worn on the arm or legs and which have printed messages thereon. While these bands are well known in the industry, there are always continuing needs to improve the enjoyment and excitement for the consumer.

### SUMMARY OF THE INVENTION

A selected figure or combination of figures or other indicia is imprinted or otherwise applied to the surface of the band at intervals throughout the length of the band, or woven or otherwise incorporated into the fabric of the band. The indicia may be of a geometric form, such as a rectangle, square, circle or ellipse; or they may be of a conventionalized form, such as a star; or of an abstract or decorative form such as an flower; or they may be letters, words, logos, a company's trademark, slogan, or even simply lines or dots or a combination of these. The indicia may appear in a single line along the center of the band, or they may appear in two or more rows, one near each side. It will be understood that regardless of the shape or form of the individual figures or the manner in which they are placed along the course of the band, the resulting pattern will be related to the elastic properties of the band in such a way that it is only visible in the stretched position. As such when the band is in the relaxed or un-stretched position, the indicia is not legible or decipherable.

### BRIEF DESCRIPTION OF THE DRAWINGS

FIG. 1 is a plan view of a section of an elastic band embodying one form of the invention, the band being in relaxed or un-stretched condition.

FIG. 2 shows the portion of the band of FIG. 1 in stretched condition.

### DESCRIPTION OF PREFERRED EMBODIMENTS

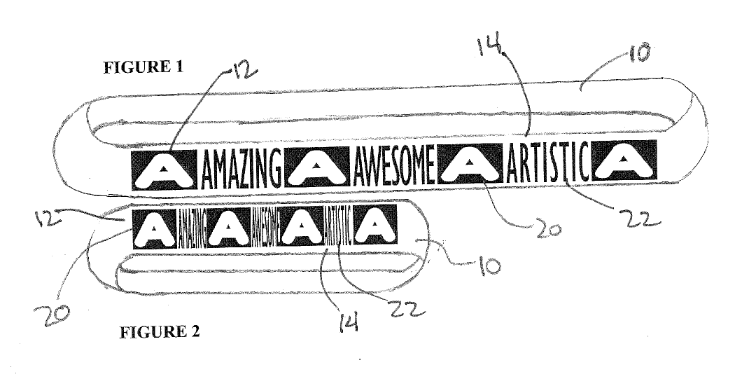

The embodiment of FIGS. 1 and 2 illustrates a pattern which consists of a single row indicia 20 crosswise and extending lengthwise across a the band 10 or a section of the band 10. The bands are worn on a user's wrist, arm, ankle, or leg or could be made larger to fit over a user's head as a necklace or could be or just made as a portion of a jewelry item, and as shown only permits the indicia to be legible when in a stretched position. In the un-stretched position the indicia becomes hidden or not legible nor decipherable.

The indicia may be selected from any type of figure or combination of figures or other imprinted or otherwise applied to the surface of the band at intervals throughout the length of the band, or at a specific location or portion of the band, and may be woven or otherwise incorporated into the fabric of the band. The indicia may be of a geometric form, such as a rectangle, square, circle or ellipse; or they may be of a conventionalized form, such as a star; or of an abstract or decorative form such as an flower; or they may be letters, words, logos, a company's trademark, slogan, or even simply lines or dots or a combination of these.

The rubber bands may be made of a type of plastic that permits the stretching and un-stretching, with the tendency to return to the un-stretched position. They may be made of a silicone, rubber, or other type of plastic.

In the method of manufacturing of the bands, it would be important to print the indicia on the band while in the stretched position, such that when un-stretched the indicia becomes hidden or no longer legible or decipherable. In addition, printing may also be done in the un-stretched position, such that a portion of indicia is legible in the stretched and a portion of indicia is only legible in the stretched position.

The advantage of the embodiment described and illustrated by FIGS. 1 and 2 is that it permits the user to have hidden messages on their bands that only them or a select others that they show in the stretched position. In all other prior art bands, the messages is printed while in the un-stretched position, such that the user always shows the message.

It will be understood that regardless of the shape or type of indicia, they will be applied to the band in a color which appropriately contrasts with the color of the band itself. Furthermore, while all of the elements of the patterns may be of the same color, if desired, different colors may be used in different arrangements.

As such there is provided in a first embodiment a band capable of being stretched and having indicia in a readily recognizable form only when the band is in a stretched condition, such form changing to an un-recognizable form when the band is in an un-stretched or relaxed position. It being made such that the indicia in the readily recognizable form is positioned only on a portion of the first material.

In a second embodiment, there is provided an elastic section of first material capable of being stretched and having indicia in a readily recognizable form only when the first material is in a stretched condition, such form changing to an un-recognizable form when the first material is in an un-stretched or relaxed position. In this embodiment, the first material is formed into a larger piece of material, such as a larger jewelry piece. It being made such that the indicia in the readily recognizable form is positioned only on a portion of the first material.

In a third embodiment, there is provided a band 10 capable of being stretched. The band having a first indicia 22 being positioned on a first portion 12 of the band and being in a readily recognizable form only when the band is in a stretched condition, such form changing to an un-recognizable form when the band is in an un-stretched position; and a second indicia 20 being positioned on a second portion 14 of the band and being in a readily recognizable form when the band is in an un-stretched position.

I claim:

1. A band capable of being stretched and having indicia in a readily recognizable form only when the band is in a stretched condition, such form changing to an un-recognizable form when the band is in an un-stretched or relaxed position.

2. The band according to claim 1 which is made of elastic material.

3. The band according to claim 1 wherein the indicia in the readily recognizable form is positioned only on a portion of the band.

4. The band according to claim 3 further comprising a second indicia in a readily recognizable form positioned on a second portion of the band and being readily recognizable when the band is in the un-stretched position.

5. A band capable of being stretched, comprising:
a first indicia being positioned on a first portion of the band and being in a readily recognizable form only when the band is in a stretched condition, such form changing to an un-recognizable form when the band is in an un-stretched position; and
a second indicia being positioned on a second portion of the band and being in a readily recognizable form when the band is in an un-stretched position.

6. The band according to claim 5 which is made of elastic material.

7. An elastic section of first material capable of being stretched and having indicia in a readily recognizable form only when the first material is in a stretched condition, such form changing to an un-recognizable form when the first material is in an un-stretched or relaxed position.

8. The first material according to claim 7 is formed into a larger piece of material.

9. The first material according to claim 7 wherein the indicia in the readily recognizable form is positioned only on a portion of the first material.

10. The first material according to claim 9 further comprising a second indicia in a readily recognizable form positioned on a second portion of the first material and being readily recognizable when the first material is in the un-stretched position.
